(19) United States
(12) Patent Application Publication
(10) Pub. No.: US 2021/0300590 A1
(43) Pub. Date: Sep. 30, 2021

(54) UNMANNED AIRCRAFT

(71) Applicant: SEIKO EPSON CORPORATION, Tokyo (JP)

(72) Inventor: Yoshitaka NAKASHIN, Matsumoto-shi (JP)

(73) Assignee: SEIKO EPSON CORPORATION, Tokyo (JP)

(21) Appl. No.: 17/213,016

(22) Filed: Mar. 25, 2021

(30) Foreign Application Priority Data
Mar. 26, 2020 (JP) 2020-055569

(51) Int. Cl. B64D 47/08; G06K 9/00; B64C 39/02; G06K 9/32

(52) U.S. Cl. CPC B64D 47/08; G06K 9/0063; B64C 2201/127; G06K 9/3233; B64C 39/024

(57) ABSTRACT

An unmanned aircraft includes a body configuring at least a part of a frame and a projecting mechanism including a projection lens, which protrudes from the body, and configured to project an image using the projection lens. The projection lens is a wide-angle lens. An object that comes into a projectable region, which is the largest region where the image is projectable by the projecting mechanism, during the projection of the image by the projecting mechanism is not attached to the body.

The present application is based on, and claims priority from JP Application Serial Number 2020-055569, filed Mar. 26, 2020, the disclosure of which is hereby incorporated by reference herein in its entirety.

### BACKGROUND

### 1. Technical Field

The present disclosure relates to an unmanned aircraft.

### 2. Related Art

There has been known an unmanned aircraft generally called drone as well. For example, a drone described in JP-A-2018-84955 (Patent Literature 1) is mounted with a projector. The projector projects and displays an image representing a pedestrian crossing or a stop sign on a road. The projector protrudes vertically downward from a frame of the drone. A plurality of legs for preventing damage to the projector and the like during landing of the drone are provided in the frame.

When one projector is mounted as in the drone described in Patent Literature 1, a wide-angle lens needs to be used as a projection lens in order to project an image with desired brightness in a wide range. However, in the drone described in Patent Literature 1, since a positional relation between the projection lens and the legs is fixed, when the wide-angle lens is used, the legs come into a projection region of the image. Therefore, chipping and the like of the image occur.

If a plurality of projectors are mounted on the drone, it is possible to expand a projectable range of the image. However, an increase in the size and an increase in the weight of a drone main body are caused according to an increase in the number of projectors.

### SUMMARY

An unmanned aircraft according to an aspect of the present disclosure includes: a body configuring at least apart of a frame; and a projecting mechanism including a projection lens, which protrudes from the body, and configured to project an image using the projection lens. The projection lens is a wide-angle lens. An object that comes into a projectable region, which is a largest region where the image is projectable by the projecting mechanism, during the projection of the image by the projecting mechanism is not attached to the body.

### BRIEF DESCRIPTION OF THE DRAWINGS

FIG. 1 is a diagram showing an example of a state of use of an unmanned aircraft according to a first embodiment.

FIG. 2 is a top view of the unmanned aircraft according to the first embodiment.

FIG. 3 is a bottom view of the unmanned aircraft according to the first embodiment.

FIG. 4 is a block diagram showing an electric configuration of the unmanned aircraft according to the first embodiment.

FIG. 5 is a diagram showing a landing completed state of the unmanned aircraft according to the first embodiment.

FIG. 6 is a diagram showing a flying state of the unmanned aircraft according to the first embodiment.

FIG. 7 is an explanatory diagram of a projectable region.

FIG. 8 is a diagram showing a flying state of an unmanned aircraft according to a second embodiment.

FIG. 9 is a diagram showing a flying state of an unmanned aircraft according to a third embodiment.

FIG. 10 is a diagram showing a flying state of an unmanned aircraft according to a fourth embodiment.

FIG. 11 is a bottom view of an unmanned aircraft according to a fifth embodiment.

FIG. 12 is a bottom view of an unmanned aircraft according to a sixth embodiment.

FIG. 13 is a bottom view of an unmanned aircraft according to a seventh embodiment.

FIG. 14 is a diagram showing a flying state of an unmanned aircraft according to a modification.

### DESCRIPTION OF EXEMPLARY EMBODIMENTS

Preferred embodiments according to the present disclosure are explained below with reference to the drawings. In the drawings, dimensions or scales of sections are different from actual ones as appropriate. There are also portions schematically shown in order to facilitate understanding. The scope of the present disclosure is not limited to these embodiments unless description to the effect that the present disclosure is limited is present in particular in the following explanation.

### 1. First Embodiment

### 1-1. Overview of an Unmanned Aircraft

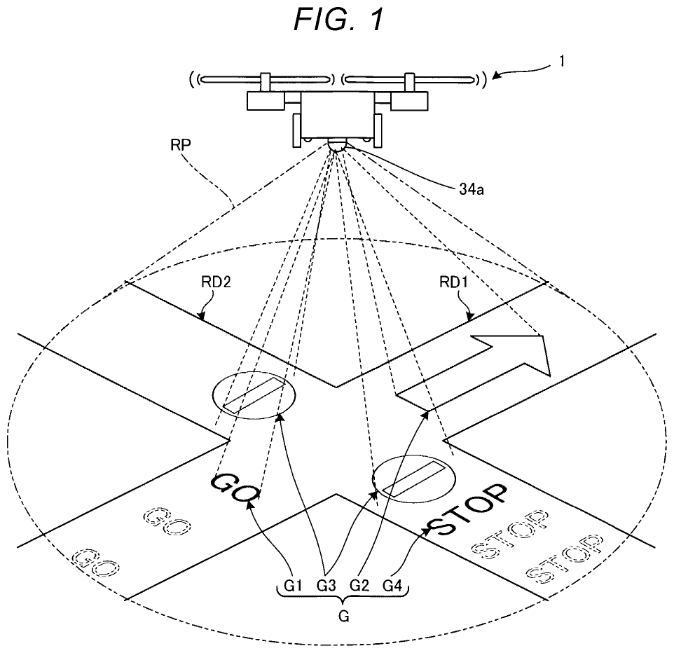

FIG. 1 is a diagram showing an example of a state of use of an unmanned aircraft 1 according to a first embodiment. The unmanned aircraft 1 is a drone having a projection function capable of displaying an image G. The unmanned aircraft 1 in this embodiment is a multirotor-type drone. In FIG. 1, when roads RD1 and RD2 forming a crossroads are used as projection surfaces, a state in which the unmanned aircraft 1 projects and displays the image G while flying is illustrated.

In the example shown in FIG. 1, the image G shows road surface signs on the roads RD1 and RD2. Specifically, the image G includes images G1, G2, G3, and G4. The image G1 is an image indicating that a person, a vehicle, or the like is allowed to pass. The image G2 is an image indicating that a person, a vehicle, or the like is allowed to enter. The image G3 is an image indicating that a person, a vehicle, or the like is prohibited from entering. The image G4 is an image indicating that a person, a vehicle, or the like has to halt. In FIG. 1, states in which display positions of the images G1 and G4 are changed are indicated by alternate long and two short dashes lines.

The image G shown in FIG. 1 is an example and is not limited to this. The image G may be an image showing road surface signs other than those shown in FIG. 1 or may be an image showing road signs or the like other than the road surface signs. Forms of the roads RD1 and RD2 are also examples and are not limited to this. Further, a projection surface onto which the image G is projected is not limited to a road and may be, for example, a wall surface of a building or a screen.

As explained in detail below, the unmanned aircraft 1 includes a projection lens 34a used for projection of the image G. The projection lens 34a is a wide-angle lens. Accordingly, compared with when a normal lens is used as the projection lens 34a, it is possible to expand a projectable region RP, which is the largest region where the image G is projectable. The unmanned aircraft 1 does not include a component that comes into the projectable region RP during the projection of the image G. Accordingly, even when the image G is projected using the entire projectable region RP, chipping or the like of the image G due to blocking of the image G by the component of the unmanned aircraft 1 is prevented. Further, since only one mechanism for projecting the image G is enough, it is possible to achieve a reduction in the size and a reduction in the weight of the unmanned aircraft 1 compared with a configuration including a plurality of the mechanisms.

### 1-2. Configuration of the Unmanned Aircraft

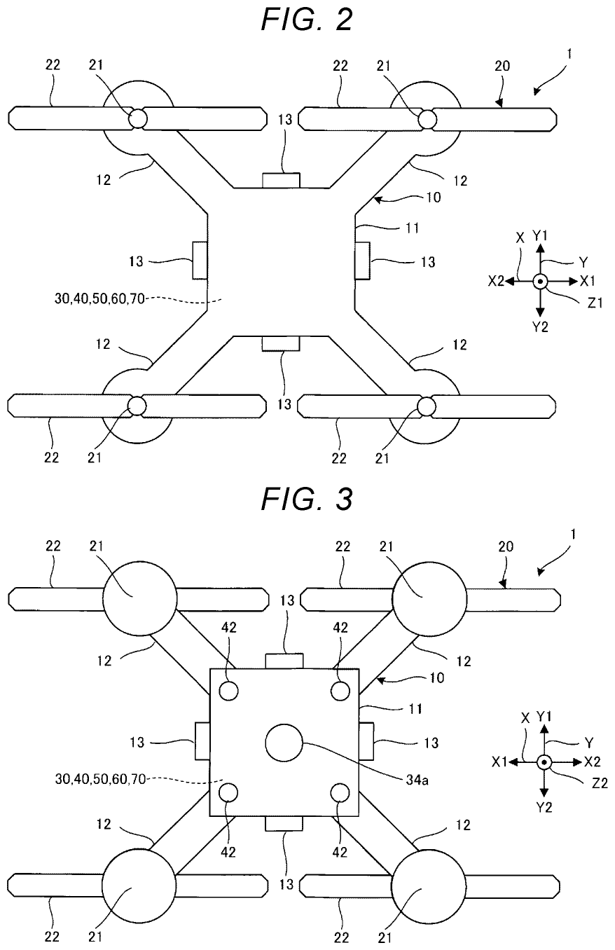

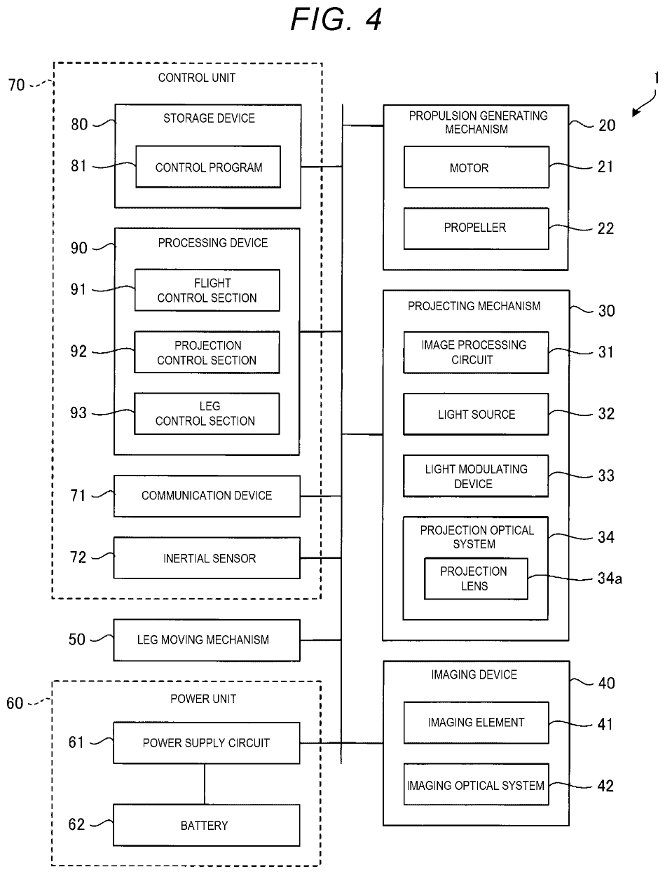

FIG. 2 is a top view of the unmanned aircraft 1 according to the first embodiment. FIG. 3 is a bottom view of the unmanned aircraft 1 according to the first embodiment. FIG. 4 is a block diagram showing an electric configuration of the unmanned aircraft 1 according to the first embodiment.

In the following explanation, for convenience of explanation, an “X axis”, a “Y axis”, and a “Z axis” orthogonal to one another are used as appropriate. One direction along the X axis is referred to as “X1 direction” and a direction opposite to the X1 direction is referred to as “X2 direction”. Similarly, one direction along the Y axis is referred to as “Y1 direction” and a direction opposite to the Y1 direction is referred to as “Y2 direction”. One direction along the Z axis is referred to as “Z1 direction” and a direction opposite to the Z1 direction is referred to as “Z2 direction”. However, X axis, the Y axis, and the Z axis are not only orthogonal to one another but also cross one another at an angle within a range of 80 degrees or more and 100 degrees or less.

As shown in FIGS. 2 and 3, the unmanned aircraft 1 includes a frame 10, a propulsion generating mechanism 20, a projecting mechanism 30, an imaging device 40, a leg moving mechanism 50, a power unit 60, and a control unit 70.

The frame 10 is a structure configuring the exterior of the unmanned aircraft 1. The frame 10 is made of, for example, a metal material, a resin material, or fiber reinforced plastic. As shown in FIGS. 2 and 3, the frame 10 includes a body 11, a plurality of arms 12, and a plurality of legs 13. In an example shown in FIGS. 2 and 3, the number of each of the arms 12 and the legs 13 is four.

The body 11 is a hollow structure. The projecting mechanism 30, the imaging device 40, the leg moving mechanism 50, the power unit 60, the control unit 70 are housed on the inside of the body 11. In the example shown in FIGS. 2 and 3, the outer surface of the body 11 is a rectangular parallelepiped. The rectangular parallelepiped includes a top surface having the Z1 direction as a normal vector, a bottom surface having the Z2 direction as the normal vector, and four side surfaces having the X1 direction, the X2 direction, the Y1 direction, and the Y2 direction as normal vectors. The shape of the body 11 is not limited to the example shown in FIGS. 2 and 3.

Each of the plurality of arms 12 is a structure protruding outward from the body 11 along an XY plane. In the example shown in FIGS. 2 and 3, the four arms 12 protrude in directions inclined with respect to the X axis and the Y axis to be disposed at equal angle intervals around the Z axis. The arms 12 protrude from parts closer to the top surface than the bottom surface of the body 11. The shape, the disposition, the number, or the like of the arms 12 is not limited to the example shown in FIGS. 2 and 3.

Each of the plurality of legs 13 is a structure protruding from the body 11 in the Z2 direction. In the example shown in FIGS. 2 and 3, the legs 13 are attached to the side surfaces of the body 11 and protrude further in the Z1 direction than the bottom surface of the body 11. In this embodiment, the legs 13 are attached to be movable along the Z axis with respect to the body 11. Accordingly, a protrusion length of the legs 13 from the body 11 can be changed. The shape, the disposition, the number, or the like of the legs 13 is not limited to the example shown in FIGS. 2 and 3.

The propulsion generating mechanism 20 is a mechanism that generates propulsion for flying the unmanned aircraft 1. The propulsion generating mechanism 20 in this embodiment is a propeller mechanism that generates not only the propulsion but also lift for flying the unmanned aircraft 1. As shown in FIGS. 2 and 3, the propulsion generating mechanism 20 includes a plurality of motors 21 and a plurality of propellers 22. The plurality of motors 21 correspond to the four arms 12. The number of the motors 21 is four. Similarly, the number of the propellers 22 is four.

Each of the plurality of motors 21 is an electric motor that rotates the propeller 22. The motors 21 are attached to the distal ends of the arms 12 corresponding to the motors 21. The motors 21 include shafts that are driven to rotate. The shafts are disposed along the Z axis. The motors 21 are not limited in particular. Various motors can be used as the motors 21.

Each of the plurality of propellers 22 is a structure including a plurality of blades that are rotated by the motor 21 to generate propulsion and lift in the unmanned aircraft 1. The propellers 22 are fixed to the shafts of the motors 21 corresponding to the propellers 22. A constituent material of the propellers 22 is not particularly limited. Examples of the constituent material include a metal material, a resin material, and fiber reinforced plastic.

The projecting mechanism 30 is a mechanism that projects the image G under control by the control unit 70. The projecting mechanism 30 includes an image processing circuit 31, a light source 32, a light modulating device 33, and a projection optical system 34.

The image processing circuit 31 is a circuit that generates, using image information received from the control unit 70, an image signal for driving the light modulating device 33. Specifically, the image processing circuit 31 includes a frame memory and generates the image signal by developing the image information in the frame memory and executing various kinds of processing such as resolution conversion processing, resize processing, and distortion correction processing as appropriate. Processing executed by the image processing circuit 31 includes processing for correcting distortion of the image G involved in aberration such as distortion aberration of the projection lens 34a explained below.

The light source 32 includes, for example, a halogen lamp, a xenon lamp, an ultrahigh pressure mercury lamp, an LED (Light Emitting Diode), or a laser light source. For example, the light source 32 emits white light or emits each of red, green, and blue lights. When the light source 32 emits the white light, variation of a luminance distribution of the light emitted from the light source 32 is reduced by a not-shown integrator optical system. Thereafter, the light is separated into red, green, and blue lights by a not-shown color separation optical system and made incident on the light modulating device 33.

The light modulating device 33 includes three light modulating elements provided to correspond to red, green, and blue lights. Each of the three light modulating elements includes, for example, a transmission-type liquid crystal panel, a reflection-type liquid crystal panel, or a DMD (digital mirror device). The three light modulating elements respectively modulate the red, green, and blue lights to generate image lights of the colors based on an image signal received from the image processing circuit 31. The image lights of the colors are combined into full-color image light by a not-shown color combination optical system.

The projection optical system 34 focuses and projects the full-color image light onto a projection surface. The projection optical system 34 is an optical system including the projection lens 34a, which is a wide-angle lens. The “wide-angle lens” means a lens, an angle of view of which is 60° or more, and is a concept including, besides a lens generally called wide-angle lens, a lens generally called super wide-angle lens or fisheye lens. Therefore, an angle of view θ of the projection lens 34a is 60° or more.

For example, when a projection distance is approximately 5 m and the image G is projected in a wide range of approximately 10 meters square, the angle of view θ of the projection lens 34a is preferably within a range of 80° or more and 180° or less, more preferably within a range of 90° or more and 170° or less, and still more preferably within a range of 100° or more and 160° or less. Since the angle of view θ is within such a range, it is easy to project the image G having desired display quality. In contrast, if the angle of view θ is too small, it is necessary to secure a longer projection distance when the image G is projected in the wide range of approximately 10 meters square. Therefore, the brightness of the image G decreases. On the other hand, if the angle of view θ is too large, brightness and resolution per unit area in the image G decrease. Therefore, display quality of the image G is deteriorated in both the cases. Because of these reasons, when the image G is projected in the wide range of approximately 10 meters square at a projection distance of approximately 5 m, the angle of view θ is preferably within the range described above.

The projection optical system 34 may include, besides the projection lens 34a, for example, a zoom lens or a focus lens.

The imaging device 40 is a device that images the projection surface. The imaging device 40 includes an imaging element 41 and an imaging optical system 42. In FIG. 4, for convenience of explanation, although not shown, the number of each of imaging elements 41 and imaging optical systems 42 is four. The number of each of the imaging elements 41 and the imaging optical systems 42 is not limited to four and may be one or more and three or less or may be five or more.

The imaging element 41 includes an imaging element such as a CCD (Charge Coupled Device) image sensor or a CMOS (Complementary MOS) image sensor. The imaging optical system 42 includes at least one lens and causes the imaging element 41 to form an object on the projection surface as an image. As shown in FIG. 3, the four imaging optical systems 42 are disposed on the bottom surface of the body 11. In an example shown in FIG. 3, the four imaging optical systems 42 are disposed at equal intervals in the circumferential direction around the projection lens 34a. The four imaging optical systems 42 are disposed such that a region imageable by the imaging device 40 includes the projectable region RP.

The leg moving mechanism 50 is a mechanism that moves the plurality of legs 13 along the Z axis with respect to the body 11 under the control by the control unit 70. More specifically, the leg moving mechanism 50 moves the leg 13 to switch a first state in which at least a part of the leg 13 is located on the inner side of the projectable region RP of the projecting mechanism 30 and a second state in which the entire leg 13 is located on the outer side of the projectable region RP. The leg moving mechanism 50 includes an actuator such as a motor and a power transmission mechanism such as a gear that transmits power of the actuator to the leg 13.

The power unit 60 supplies electric power to the sections of the unmanned aircraft 1 under the control by the control unit 70. The power unit 60 includes a power supply circuit 61 and a battery 62. The power supply circuit 61 supplies electric power to the sections of the unmanned aircraft 1 using the electric power supplied from the battery 62. The battery 62 is a battery such as a lithium ion battery.

The control unit 70 controls the operation of the sections of the unmanned aircraft 1. The control unit 70 includes a communication device 71, an inertial sensor 72, a storage device 80, and a processing device 90.

The communication device 71 is a device capable of communicating with an external communication device by wire or radio. For example, the communication device 71 includes a wired communication device such as a wired LAN (Local Area Network), a USB (Universal Serial Bus), or an HDMI (High Definition Multimedia Interface) or a wireless communication device such as an LPWA (Low Power Wide Area), a wireless LAN including Wi-Fi, or a Bluetooth. The communication device 71 may include a receiver that receives a satellite signal such as a GPS (Global Positioning System) signal. Each of “HDMI” and “Bluetooth” is a registered trademark.

The inertial sensor 72 is a sensor that detects a physical quantity such as acceleration or angular velocity. For example, the inertial sensor 72 includes an angular velocity sensor that detects angular velocities around three axes orthogonal to one another and an acceleration sensor that detects acceleration along each of the three axes. An output of such an inertial sensor 72 changes according to a change of the position or the posture of the unmanned aircraft 1.

The storage device 80 is a storage device that stores a control program 81 to be executed by the processing device 90 and various kinds of information to be processed by the processing device 90. The storage device 80 is configured by, for example, a hard disk drive or a semiconductor memory. A part or all of the information stored in the storage device 80 may be stored in advance or may be acquired from the outside of the unmanned aircraft 1 via the communication device 71.

The processing device 90 is a processing device having a function of controlling the operation of the sections of the unmanned aircraft 1 and a function of processing various data. The processing device 90 includes, for example, a CPU (Central Processing Unit). The processing device 90 executes the control program 81 stored in the storage device 80 to thereby function as a flight control section 91, a projection control section 92, and a leg control section 93. The processing device 90 may be configured by a single processor or may be configured by a plurality of processors. A part or all of the functions of the processing device 90 may be realized by hardware such as a DSP (Digital Signal Processor), an ASIC (Application Specific Integrated Circuit), a PLD (Programmable Logic Device), or an FPGA (Field Programmable Gate Array).

The flight control section 91 controls the operation of the propulsion generating mechanism 20. For example, the flight control section 91 controls the operation of the propulsion generating mechanism 20 such that the unmanned aircraft 1 flies along an instructed flight path. For example, information concerning the flight path is set in the control program 81 in advance or acquired via the communication device 71. The flight control section 91 controls the operation of the propulsion generating mechanism 20 based on a detection result of the inertial sensor 72 such that the unmanned aircraft 1 takes a desired position and a desired posture. When the communication device 71 is capable of receiving a satellite signal, the flight control section 91 may control the operation of the propulsion generating mechanism 20 using position information based on the satellite signal such that the unmanned aircraft 1 takes a desired position.

The projection control section 92 controls the operation of the projecting mechanism 30. For example, the projection control section 92 controls the operation of the projecting mechanism 30 to display the image G. For example, information concerning the image G is set in the control program 81 in advance or acquired via the communication device 71. The projection control section 92 may control the operation of the projecting mechanism 30 based on an imaging result of the imaging device 40 to apply predetermined image processing to the information concerning the image G.

The leg control section 93 controls the operation of the leg moving mechanism 50. Specifically, the leg control section 93 changes a protrusion length of the legs 13 according to operation states of the propulsion generating mechanism 20 and the projecting mechanism 30.

### 1-3. Relative Positional Relation Between the Legs 13 and the Projection Lens 34a

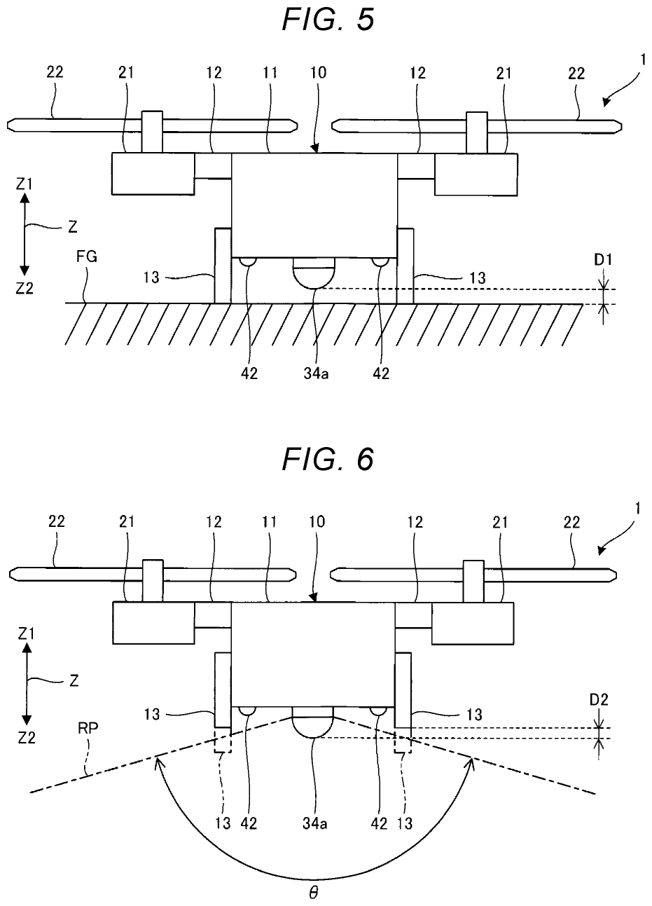

FIG. 5 is a diagram showing a landing completed state of the unmanned aircraft 1 according to the first embodiment. As shown in FIG. 5, in the unmanned aircraft 1 in the landing completed state, the distal ends of the legs 13 are in contact with a ground FG. At this time, the distal ends of the legs 13 are located further in the Z2 direction than the distal end of the projection lens 34a. That is, a distance D1 along the Z axis between the distal end of the leg 13 and the distal end of the projection lens 34a is set to a degree at which the distal end of the projection lens 34a does not come into contact with the ground FG. Accordingly, the distal end of the projection lens 34a does not come into contact with the ground FG. As a result, the projection lens 34a is prevented from being damaged by the contact with the ground FG.

A state of a relative positional relation between the legs 13 and the projection lens 34a shown in FIG. 5 is an example of a first state in which a part of or the entire each of the plurality of legs 13 comes into the projectable region RP.

FIG. 6 is a diagram showing a flying state of the unmanned aircraft 1 according to the first embodiment. As shown in FIG. 6, in the unmanned aircraft 1 in the flying state, the distal ends of the legs 13 are located further in the Z1 direction than the distal end of the projection lens 34a. The distal ends of the legs 13 are located on the outer side of the projectable region RP. That is, a distance D2 along the Z axis between the distal end of the leg 13 and the distal end of the projection lens 34a is set to a degree at which the distal end of the leg 13 is located on the outer side of the projectable region RP. Accordingly, the state of the relative positional relation between the legs 13 and the projection lens 34a shown in FIG. 6 is an example of a second state in which the entire each of the plurality of legs 13 does not come into the projectable region RP.

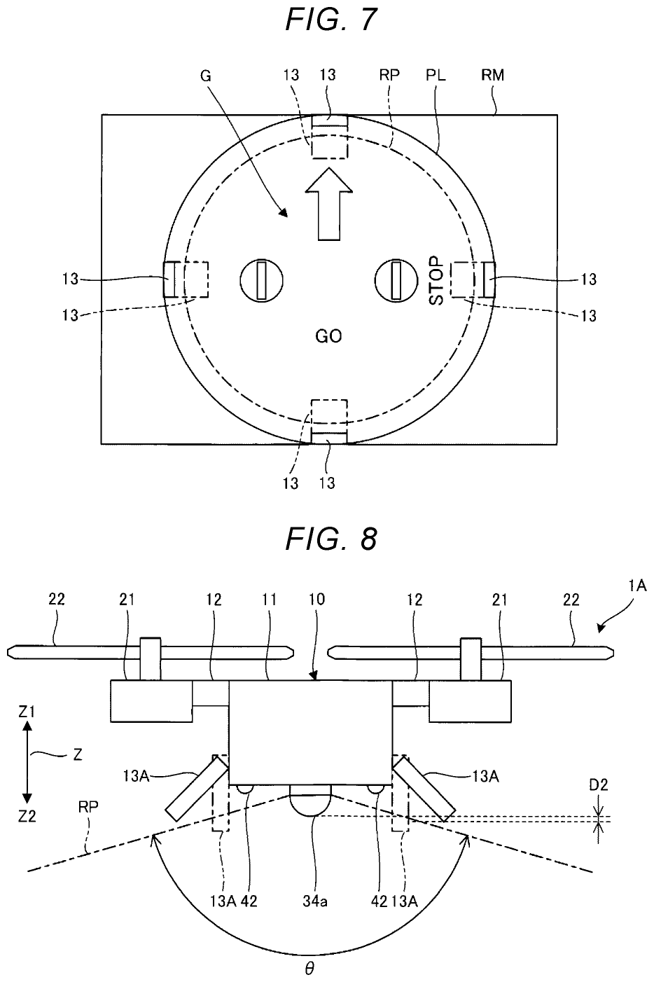

FIG. 7 is an explanatory diagram of the projectable region RP. The projectable region RP is a space occupied by a path of light emitted when the projecting mechanism 30 projects the largest image. As shown in FIG. 7, the projectable region RP is set on the inner side of a region PL corresponding to the entire region of the projection lens 34a. In FIG. 7, as an example, the region PL is set on the inner side of an effective region RM of the light modulating device 33. The projectable region RP may be set according to a positional relation between the projection lens 34a and the effective region RM of the light modulating device 33 or may be set in a software manner according to image information or the like received from the control unit 70.

In the first state, as indicated by an alternate long and two short dashes line in FIG. 7, a part of each of the legs 13 is located on the inner side of the projectable region RP. In contrast, in the second state, as indicated by a solid line in FIG. 7, the entire each of the legs 13 is located on the outer side of the projectable region RP. In FIG. 7, as an example, the shape of the projectable region RP on the projection surface is a circle. However, the shape is not limited to the circle and may be, for example, a polygon such as a square, an ellipse, or a star shape.

The unmanned aircraft 1 includes the body 11 and the projecting mechanism 30 as explained above. The body 11 configures at least a part of the frame 10. The projecting mechanism 30 includes the projection lens 34a protruding from the body 11 and projects the image G using the projection lens 34a.

The projection lens 34a is the wide-angle lens. Accordingly, compared with when a normal lens is used as the projection lens 34a, it is possible to expand the projectable region RP, which is the largest region where the image G is projectable by the projecting mechanism 30. Moreover, an object that comes into the projectable region RP during the projection of the image G by the projecting mechanism 30 is not attached to the body 11. Accordingly, even when the image G is projected using the entire projectable region RP, chipping or the like of the image G due to blocking of the image G by a component of the unmanned aircraft 1 is prevented. Further, since only one projecting mechanism 30 is enough, it is possible to achieve a reduction in the size of the unmanned aircraft 1 compared with a configuration including a plurality of projecting mechanisms 30.

As explained above, the unmanned aircraft 1 further includes the plurality of legs 13 attached to the body 11. The unmanned aircraft 1 switches, based on an operation state of the projecting mechanism 30, a first state in which at least a part of or the entire each of the plurality of legs 13 comes into the projectable region RP and a second state in which the entire each of the plurality of legs 13 does not come into the projectable region RP.

In the first state, it is possible to bring the plurality of legs 13 into contact with the ground FG without bringing the projection lens 34a into contact with the ground FG. Accordingly, it is possible to prevent damage to the projection lens 34a, for example, during landing of the unmanned aircraft 1. In contrast, in the second state, even when the image G is projected using the entire projectable region RP, chipping or the like of the image G due to blocking of the image G by the legs 13 is prevented. Accordingly, it is possible to project a desired image Gin a wide range during flight of the unmanned aircraft 1.

In this embodiment, a protrusion length of each of the plurality of legs 13 from the body 11 can be changed. The unmanned aircraft 1 switches the first state and the second state according to the change of the protrusion length. In such switching of the first state and the second state, compared with switching in a second embodiment explained below, a moving distance of the distal ends of the legs 13 may be short. Therefore, there is an advantage that a time required for the switching may be short, air resistance applied to a main body from the external world decreases, and flight is stabilized.

### 2. Second Embodiment

A second embodiment of the present disclosure is explained below. In a form illustrated below, components having the same action and the same functions as those of the components in the first embodiment are denoted by the same reference numerals and signs in the first embodiment and detailed explanation of the components is omitted as appropriate.

FIG. 8 is a diagram showing a flying state of an unmanned aircraft 1A according to the second embodiment. The unmanned aircraft 1A is the same as the unmanned aircraft 1 in the first embodiment except that the unmanned aircraft 1A includes a plurality of legs 13A instead of the plurality of legs 13.

Each of the plurality of legs 13A is swingably attached to the body 11 to be able to take a state in which the leg 13A is located further in the Z1 direction than the projection lens 34a and a state in which the leg 13A is located further in the Z2 direction than the projection lens 34a. In an example shown in FIG. 8, each of the legs 13A is formed in a longitudinal shape and swings around one end of the leg 13A.

According to the second embodiment, the same effects as the effects in the first embodiment are obtained. In this embodiment, the posture of each of the plurality of legs 13A with respect to the body 11 can be changed. The unmanned aircraft 1A switches the first state and the second state according to the change of the posture. In such change of the first state and the second state, since an attachment position of the leg 13A to the body 11 can be fixed, compared with the switching in the first embodiment, there is an advantage that a reduction in the size of a mechanism for moving the distal end of the leg 13A can be easily achieved.

### 3. Third Embodiment

A third embodiment of the present disclosure is explained below. In a form illustrated below, components having the same action and the same functions as those of the components in the first embodiment are denoted by the same reference numerals and signs in the first embodiment and detailed explanation of the components is omitted as appropriate.

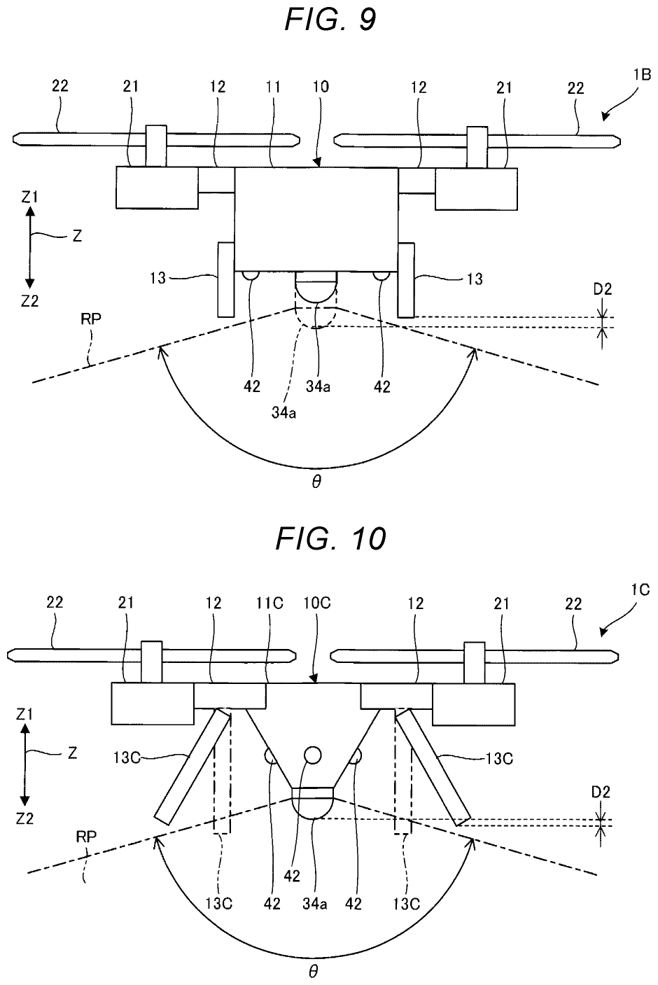

FIG. 9 is a diagram showing a flying state of an unmanned aircraft 1B according to the third embodiment. The unmanned aircraft 1B is the same as the unmanned aircraft 1 in the first embodiment except that the projection lens 34a is movable along the Z axis with respect to the body 11. In this embodiment, the legs 13 only has to be fixed to the body 11 in the same positions as the positions in the first state in the first embodiment. Therefore, the leg moving mechanism 50 in the first embodiment may be omitted.

The projection lens 34a is attached to be movable along the Z axis with respect to the body 11 by a not-shown moving mechanism to be able to take a state in which the projection lens 34a is located further in the Z1 direction than the distal ends of the legs 13 and a state in which the projection lens 34a is located further in the Z2 direction than the distal ends of the legs 13. The moving mechanism includes an actuator such as a motor and a power transmitting mechanism such as a gear that transmits power from the actuator to the projection lens 34a.

According to the third embodiment explained above, the same effects as the effects in the first embodiment are obtained. In this embodiment, the position of the projection lens 34a with respect to the body 11 can be changed. The unmanned aircraft 1B switches the first state and the second state according to the change of the position. In such switching of the first state and the second state, only one projection lens 34a has to be moved with respect to the body 11. Therefore, compared with the switching in the first embodiment, a moving mechanism for the switching is unnecessary. Consequently, there is an advantage that a reduction in the weight of a main body can be achieved.

The distal end of the projection lens 34a in the second embodiment is located further forward in the projecting direction of the projecting mechanism 30, that is, further in the Z2 direction than each of the plurality of legs 13. Accordingly, even when the angle of view of the projection lens 34a is approximately 180°, the leg 13 is prevented from coming into the projectable region RP.

### 4. Fourth Embodiment

A fourth embodiment of the present disclosure is explained below. In a form illustrated below, components having the same action and the same functions as those of the components in the first embodiment are denoted by the same reference numerals and signs in the first embodiment and detailed explanation of the components is omitted as appropriate.

FIG. 10 is a diagram showing a flying state of an unmanned aircraft 1C according to the fourth embodiment. The unmanned aircraft 1C is the same as the unmanned aircraft 1 in the first embodiment except that the unmanned aircraft 1C includes a frame 10C and a plurality of legs 13C instead of the frame 10 and the plurality of legs 13.

The frame 10C is the same as the frame 10 in the first embodiment except that the frame 10C includes a body 11C instead of the body 11. The external shape of the body 11C is a quadrangular pyramid shape, the width of which decreases in the Z2 direction. The projection lens 34a is disposed at the end in the Z2 direction of the body 11C. The imaging optical systems 42 are disposed on the side surfaces of the body 11C.

Like the plurality of legs 13A in the second embodiment, each of the plurality of legs 13C is swingably attached to the body 11C to be able to take a state in which the leg 13C is located further in the Z1 direction than the projection lens 34a and a state in which the leg 13C is located further in the Z2 direction than the projection lens 34a.

According to the fourth embodiment explained above, the same effects as the effects in the first embodiment are obtained. In this embodiment, the projection lens 34a is disposed at the distal end of the body 11C having the quadrangular pyramid shape. Accordingly, other objects less easily come into the projectable region RP. The imaging optical systems 42 are disposed on the side surfaces of the body 11C having the quadrangular pyramid shape. Accordingly, compared with the configuration in which the imaging optical systems 42 are disposed on the bottom surface of the body 11 as in the first embodiment, it is easy to expand the range imageable by the imaging device 40.

### 5. Fifth Embodiment

A fifth embodiment of the present disclosure is explained below. In a form illustrated below, components having the same action and the same functions as those of the components in the first embodiment are denoted by the same reference numerals and signs in the first embodiment and detailed explanation of the components is omitted as appropriate.

FIG. 11 is a bottom view of an unmanned aircraft 1D according to the fifth embodiment. The unmanned aircraft 1D is the same as the unmanned aircraft 1 in the first embodiment except that the unmanned aircraft 1D includes a frame 10D instead of the frame 10.

The frame 10D is the same as the frame 10 in the first embodiment except that the frame 10D includes a body 11D instead of the body 11. The external shape of the body 11D is a conical shape, the width of which decreases in the Z2 direction. The projection lens 34a is disposed at the end in the Z2 direction of the body 11D. Four imaging optical systems 42 are disposed on the side surfaces of the body 11D.

According to the fifth embodiment explained above, the same effects as the effects in the first embodiment are obtained. In this embodiment, the projection lens 34a is disposed at the distal end of the body 11D having the conical shape. Accordingly, other objects less easily come into the projectable region RP. The imaging optical systems 42 are disposed on the side surfaces of the body 11D having the conical shape. Accordingly, compared with the configuration in which the imaging optical systems 42 are disposed on the bottom surface of the body 11 as in the first embodiment, it is easy to expand the range imageable by the imaging device 40.

### 6. Sixth Embodiment

A sixth embodiment of the present disclosure is explained below. In a form illustrated below, components having the same action and the same functions as those of the components in the first embodiment are denoted by the same reference numerals and signs in the first embodiment and detailed explanation of the components is omitted as appropriate.

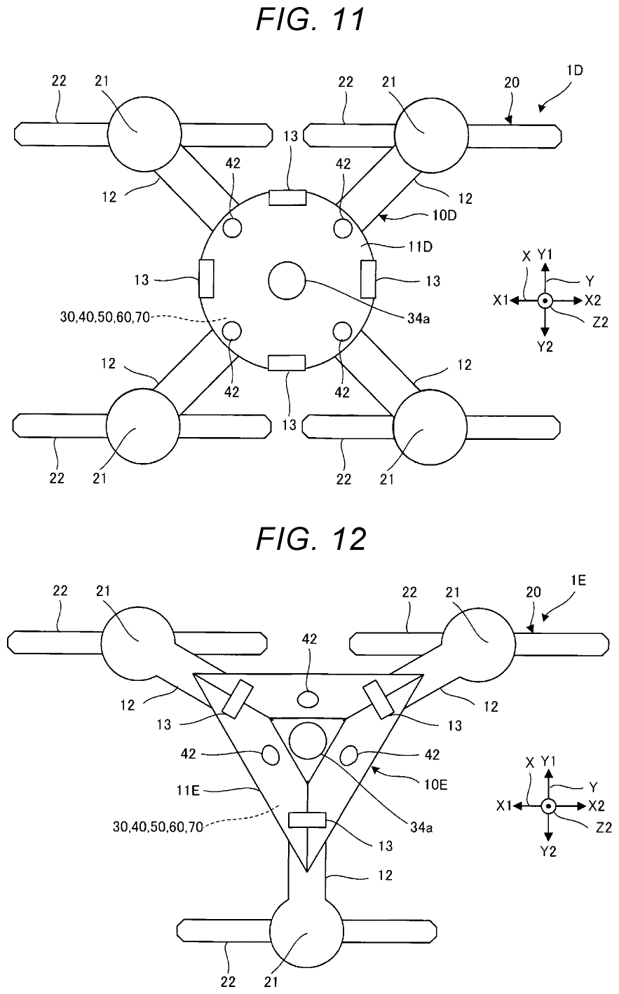

FIG. 12 is a bottom view of an unmanned aircraft 1E according to the sixth embodiment. The unmanned aircraft 1E is the same as the unmanned aircraft 1 in the first embodiment except that the number of the imaging optical systems 42, the motors 21, and the propellers 22 is different and the unmanned aircraft 1E includes a frame 10E instead of the frame 10.

The frame 10E is the same as the frame 10 in the first embodiment except that the number of the arms 12 and the legs 13 is different and the frame 10E includes a body 11E instead of the body 11. The external shape of the body 11E is a triangular pyramid shape, the width of which decreases in the Z2 direction. The projection lens 34a is disposed at the end in the Z2 direction of the body 11E. The imaging optical systems 42 are disposed on the side surfaces of the body 11E. Three arms 12 are connected to the body 11E.

According to the sixth embodiment explained above, the same effects as the effects in the first embodiment are obtained. In this embodiment, the projection lens 34a is disposed at the distal end of the body 11E having the triangular pyramid shape. Accordingly, other objects less easily come into the projectable region RP. The imaging optical systems 42 are disposed on the side surfaces of the body 11E having the triangular pyramid shape. Accordingly, compared with the configuration in which the imaging optical systems 42 are disposed on the bottom surface of the body 11 as in the first embodiment, it is easy to expand the range imageable by the imaging device 40.

### 7. Seventh Embodiment

A seventh embodiment of the present disclosure is explained below. In a form illustrated below, components having the same action and the same functions as those of the components in the first embodiment are denoted by the same reference numerals and signs in the first embodiment and detailed explanation of the components is omitted as appropriate.

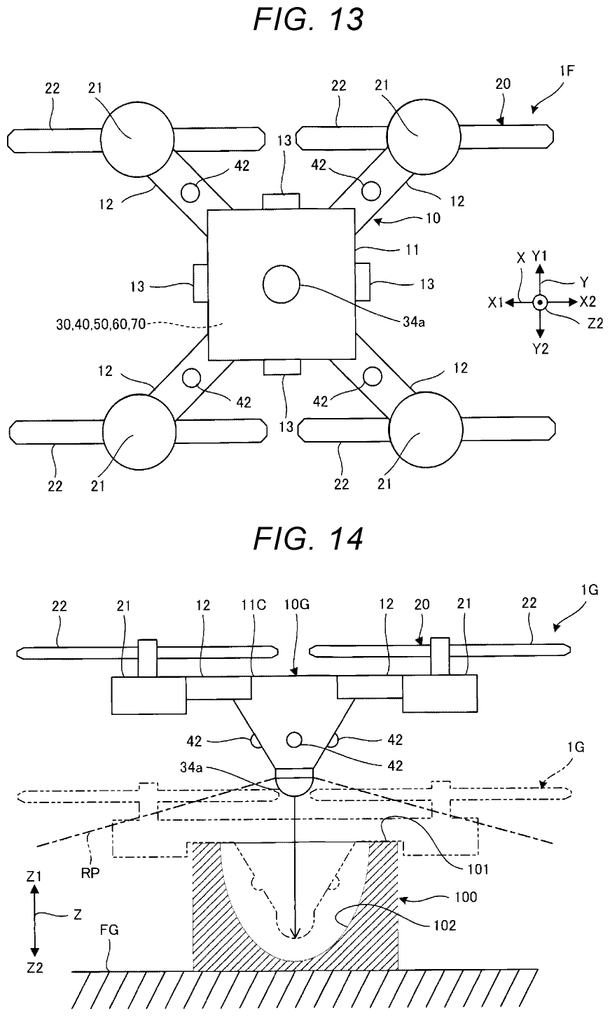

FIG. 13 is a bottom view of an unmanned aircraft 1F according to the seventh embodiment. The unmanned aircraft 1F is the same as the unmanned aircraft 1 in the first embodiment except that the disposition of the imaging optical systems 42 is different. In this embodiment, the imaging optical systems 42 are disposed in the arms 12. According to the seventh embodiment explained above, the same effects as the effects in the first embodiment are obtained.

### 8. Modifications

The forms illustrated above can be variously modified. Aspects of specific modifications applicable to the forms described above are illustrated below. Two or more aspects optionally selected out of the following illustrations can be combined as appropriate in a range in which the forms are not contradictory to one another.

In the forms explained above, the configuration in which the legs are provided in the body of the frame is illustrated. However, the legs are not limited to this. For example, the legs may be provided in the arms of the frame or may be omitted. The number of the legs is not limited to the illustration in the forms and is optional.

FIG. 14 is a diagram showing a flying state of an unmanned aircraft 1G according to a modification. The unmanned aircraft 1G is the same as the unmanned aircraft 1C in the fourth embodiment except that the legs 13C are omitted. In this case, if a stand 100 for landing illustrated in FIG. 14 is used, it is possible to prevent damage to the projection lens 34a during landing. The stand 100 includes an upper surface 101 and a recess 102 provided on the upper surface 101. The upper surface 101 comes into contact with the plurality of arms 12 of the unmanned aircraft 1G during landing. The recess 102 houses the body 11C. The width, the depth, and the like of the recess 102 are set to degrees at which the stand 100 does not come into contact with the projection lens 34a.

In the forms explained above, the configuration in which the unmanned aircraft 1 is the multirotor-type rotary wing aircraft is illustrated. However, the unmanned aircraft 1 is not limited to this illustration. For example, the unmanned aircraft 1 may be another rotary wing aircraft of a single rotor type or a twin rotor type. The unmanned aircraft 1 is not limited to the rotary wing aircraft and may be another aircraft such as a fixed wing aircraft.

What is claimed is:

1. An unmanned aircraft comprising:
a body configuring at least a part of a frame; and
a projecting mechanism including a projection lens, which protrudes from the body, and configured to project an image using the projection lens, wherein
the projection lens is a wide-angle lens, and
an object that comes into a projectable region, which is a largest region where the image is projectable by the projecting mechanism, during the projection of the image by the projecting mechanism is not attached to the body.

2. The unmanned aircraft according to claim 1, further comprising a plurality of legs attached to the body, wherein
the unmanned aircraft switches, based on an operation state of the projecting mechanism, a first state in which a part of or entire each of the plurality of legs comes into the projectable region and a second state in which the entire each of the plurality of legs does not come into the projectable region.

3. The unmanned aircraft according to claim 2, wherein
a protrusion length of each of the plurality of legs from the body can be changed, and
the unmanned aircraft switches the first state and the second state according to the change of the protrusion length.

4. The unmanned aircraft according to claim 2, wherein
a posture of each of the plurality of legs with respect to the body can be changed, and
the unmanned aircraft switches the first state and the second state according to the change of the posture.

5. The unmanned aircraft according to claim 2, wherein
a position of the projection lens with respect to the body can be changed, and
the unmanned aircraft switches the first state and the second state according to the change of the position.

6. The unmanned aircraft according to claim 5, wherein a distal end of the projection lens in the second state is located further forward in a projecting direction of the projecting mechanism than each of the plurality of legs.
